(19) United States
(12) Patent Application Publication
(10) Pub. No.: US 2026/0243865 A1
(43) Pub. Date: Aug. 20, 2026

(54) Road surface characterization

(71) Applicant: Teknologian tutkimuskeskus VTT Oy, Espoo (FI)

(72) Inventors: Mervi Hirvonen, Espoo (FI); Jussi Varis, Espoo (FI); Pekka Rantakari, Espoo (FI)

(21) Appl. No.: 19/164,600

(22) PCT Filed: Mar. 7, 2024
(86) PCT No.: PCT/FI2024/050098

§ 371 Date: Sep. 12, 2025

(30) Foreign Application Priority Data
Mar. 14, 2023 (FI) 20235298

(51) Int. Cl. G01S 7/00; G01N 22/04; G01S 7/02; G01S 7/41; G01S 13/42; G01S 13/931; G01S 13/95; G01W 1/14; G08B 27/00

(52) U.S. Cl. CPC G01S 7/006; G01N 22/04; G01S 7/026; G01S 7/411; G01S 13/42; G01S 13/931; G01S 13/956; G01W 1/14; G08B 27/006; G01W 2203/00

(57) ABSTRACT

According to an example aspect of the present invention, there is provided an apparatus configured at least to switch a cellular transceiver repeatedly between a cellular operating mode and a polarimetry operating mode, wherein in the polarimetry operating mode the cellular transceiver transmits, using beamforming, a signal comprising orthogonal polarization components and measures reflected or backscattered energy originating in the transmitted signal, and estimate, based on polarization measurement data obtained from the reflected or backscattered energy, whether a road surface toward which the transmitted signal is directed is wet or icy.

### FIELD

The present disclosure relates to characterizing a road surface using polarimetric measurements.

### BACKGROUND

Road icing is a challenge present in road networks which experience cold weather, since friction provided by an iced road is significantly less than a non-iced, asphalt- or concrete-surfaced road. Further, a road surface may unexpectedly develop icing, causing the friction available to vehicles to change without warning, causing a risk of traffic accidents. Road icing may take place even when air temperature is not below water's freezing point due to radiative heat loss from the road surface.

Similarly to icing, water on a road surface is a traffic hazard as a wet surface provides less friction than a dry one. Furthermore, a water layer on the road may cause aquaplaning, a dangerous situation where a vehicle tyre loses contact with the road, potentially causing an overall loss of control for a vehicle.

Traction in the presence of ice has been improved by using studded tyres in cars, whereas the risk of aquaplaning has been reduced by maintaining roads in good repair, such that water doesn't pool on the road surface.

### SUMMARY

According to some aspects, there is provided the subject-matter of the independent claims. Some embodiments are defined in the dependent claims.

According to a first aspect of the present disclosure, there is provided an apparatus comprising at least one processing core and at least one memory storing instructions that, when executed by the at least one processing core, cause the apparatus at least to switch a cellular transceiver repeatedly between a cellular operating mode and a polarimetry operating mode, wherein in the polarimetry operating mode the cellular transceiver transmits, using beamforming, a signal comprising orthogonal polarization components and measures reflected or backscattered energy originating in the transmitted signal, and estimate, based on polarization measurement data obtained from the reflected or backscattered energy, whether a road surface toward which the transmitted signal is directed is wet or icy.

According to a second aspect of the present disclosure, there is provided a method comprising switching, by an apparatus, a cellular transceiver repeatedly between a cellular operating mode and a polarimetry operating mode, wherein in the polarimetry operating mode the cellular transceiver transmits, using beamforming, a signal comprising orthogonal polarization components and measures reflected or backscattered energy originating in the transmitted signal, and estimating, based on polarization measurement data obtained from the reflected or backscattered energy, whether a road surface toward which the transmitted signal is directed is wet or icy.

According to a third aspect of the present disclosure, there is provided a non-transitory computer readable medium having stored thereon a set of computer readable instructions that, when executed by at least one processor, cause an apparatus to at least switch a cellular transceiver repeatedly between a cellular operating mode and a polarimetry operating mode, wherein in the polarimetry operating mode the cellular transceiver transmits, using beamforming, a signal comprising orthogonal polarization components and measures reflected or backscattered energy originating in the transmitted signal, and estimate, based on polarization measurement data obtained from the reflected or backscattered energy, whether a road surface toward which the transmitted signal is directed is wet or icy.

### BRIEF DESCRIPTION OF THE DRAWINGS

FIG. 1 illustrates an example system in accordance with at least some embodiments of the present invention;

FIG. 2A illustrates timing in accordance with at least some embodiments of the present invention;

FIG. 2B illustrates circular and elliptical polarizations;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Methods are herein disclosed which enable characterization of a road surface as dry, wet or icy based on polarization measurement data obtained from a signal transmitted by a cellular base station, when operating in a polarimetric mode. The wet or icy condition is determined based on polarization features imparted onto the signal in reflection or backscattering processes from the road surface.

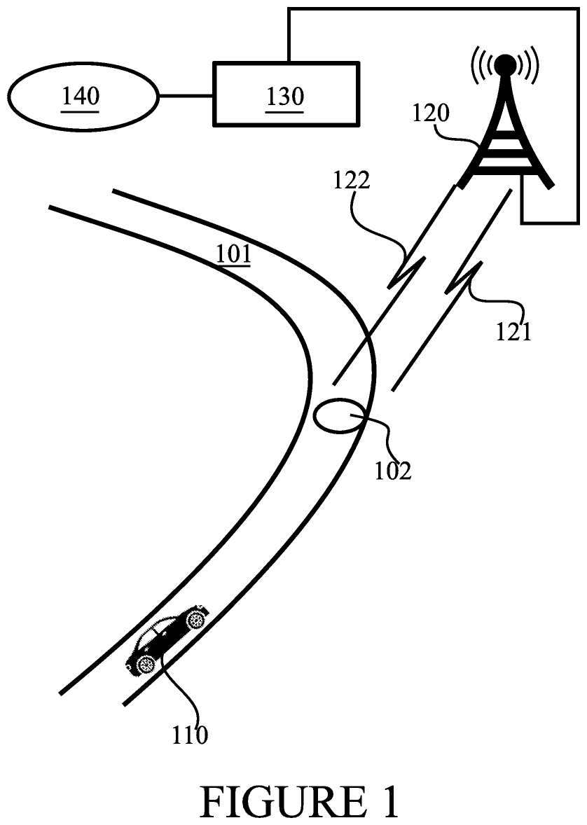

FIG. 1 illustrates an example system in accordance with at least some embodiments of the present invention. Car 110 is driving along road 101. In general, car 110 is an example of a vehicle which may be arranged to operate as herein described. Other examples of suitable vehicles include a van, a truck, a motorcycle and a bicycle. Road 110 may be paved with asphalt or it may be built of concrete slabs, for example.

Car 110, or more generally the vehicle, may comprises a cellular transceiver. By a cellular transceiver it is meant a device configured to attach itself to a cellular communication network by operating according to a cellular radio communication standard, such as, for example, wideband code division multiple access, WCDMA, long term evolution, LTE, or fifth generation, 5G, which may alternatively be referred to as new radio, NR. The cellular transceiver may be fixedly installed in the vehicle, such as car 110, or it may be a transceiver of a driver or passenger in the vehicle, for example a transceiver of a smartphone or tablet device of the driver or passenger.

Base station 120 is comprised in the cellular communication network. This network may comprise a radio access network, RAN, which may comprise even hundreds or thousands of base stations. Each base station may control one or more cells, for example sectorized cells. A cell may employ beamforming in reception and/or transmission to achieve directionality to its operation, which improves energy efficiency of communications.

Base station 120 is coupled with a node 130 in a core network, and the core network in turn is coupled with a further network 140, which may be the Internet, for example. Node 130 may be a mobility management entity, MME, or an access and mobility management function, AMF, for example, depending on the technology used.

The cellular communication network and the cellular transceiver use the same technology to obtain interoperability of the cellular transceiver with the network. Thus the cellular transceiver may enable a user equipment, UE, where the cellular transceiver is comprised to remain attached to the network as car 110 travels even large distances, by performing handovers between cells to maintain a feasible connection to at least one cell of the network at all times. In detail, cellular networks are often deployed in a manner, that roads are in their entirety within coverage of the network, even outside urban areas.

Base station 120 is configured to transmit in the downlink direction, that is, from the base station to user equipments of the network, and to receive in the uplink direction, that is, receive at the base station signals transmitted from the user equipments of the network. A downlink signal 121 is illustrated in FIG. 1, and a reflected or backscattered signal 122, which is also a downlink signal deriving from signal 121. In detail, signal 122 is reflected or scattered from patch 102 on the road, which is an icy or wet patch. Signal 122 may comprise both a reflected part and a backscattered part, in other words, it may be both backscattered and reflected. Signal 122 comprises reflected or backscattered energy originating in the transmitted signal 121.

Signals 121 and 122 may be double polarized signals comprising orthogonally polarized components. The reflection and/or scattering from patch 102 will modify the polarization, such that signal 122 has a polarization state different from signal 121. Signal 121 is transmitted from base station 120 using a double polarized antenna.

Signal 121 may be a signal that base station 120 transmits while in a polarimetry operating mode. Base station 120, or at least a beam provided by the base station, may be switched to a polarimetry mode wherein signal 121 is transmitted, which may be devoid of encoding with information bits. Base station 120 also has at least one cellular transceiver it uses to transmit in the downlink and receive in the uplink. In other words, signal 121 is provided in the beam, sector or cell instead of a cellular signal encoded with information bits, the information bits conveying a message to UE devices. Signal 121 may carry instead of modulated cellular information bits for a UE a polarization state, which as described above is a double polarized state comprising orthogonally polarized components. For example, signal 121 may be circularly polarized when transmitted from base station 120. In some embodiments signal 121 comprises a part encoded with information bits and a part not encoded with information bits. In these embodiments, the part not encoded with information bits may be larger, that is, longer in time, than the part encoded with information bits. In some embodiments signal 121 is encoded with some information, using a different modulation than when base station 120 is not in the polarimetry mode. When in the polarimetry mode the cellular transceiver of base station 120 measures signal 122. The polarimetry mode may also be referred to as a polarimetric sensing mode.

Base station 120 may determine to enter the polarimetry mode when it has a lower loading state with respect to cellular communication with UEs. For example, base station 120 may enter and exit the polarimetry mode, conducting an icing measurement while in the polarimetry mode, as a response to determining that a number of UE devices attached to a cell controlled by base station 120 decreases to below a threshold number. The benefit of this is, that the impact of the polarimetry mode on cellular communications is lower when there are fewer UEs attached in the cell.

The polarization state of signal 122 may differ from the polarization state of signal 121 in terms of one or more of the following: a circular polarization ratio, a polarization entropy, and/or a polarization pedestal. In detail, the circular polarization ratio may assume a value closer to one in case patch 102 is icy or wet, compared to a situation where patch 102, or the road surface in general, is dry. Patch 102 may be estimated by e.g. base station 120 to be icy as a response to the circular polarization ratio of signal 122 being in excess of a preconfigured threshold.

By circular polarization ratio, CPR, it is meant a measure of a quality of a reflected or scattered signal received by a circular polarization receiver. When in the polarimetry operating mode, the cellular transceiver of base station 120 operates as a radar transmitter and receiver. Signal 121 may be transmitted as a circularly-polarized signal, and the CPR is a ratio of the amount of reflected or backscattered signal that is polarized in the same manner as in signal 121 to the amount signal polarized in an opposite direction. Circular polarization is the form of a wave signal such that at each point in an oscillation the wave remains at its peak amplitude, which is constant, the oscillation occurring in the peak's direction perpendicular to the direction of the signal, rotating about the propagation direction like a clock hand. If, while looking in the direction of the radiation source, the electric field vector appears to be rotating counter-clockwise, the light is called right-circularly polarized. If the vector appears to be rotating clockwise, the light is called left-circularly polarized. Circular polarization radar has an ability to determine characteristics of the texture of a reflecting material .

By polarization entropy it is meant a measure of the randomness of the scattering process and has a value of 0 for a single non-random target and 1 for a highly random distributed target. It can be calculated from the eigenvalues of the coherence or covariance matrix.

By polarization pedestal it is meant a measure of the degree of depolarization generated by the target. It can be calculated from the eigenvalues of the coherence or covariance matrix.

The cellular transceiver of base station 120 may be switched repeatedly between a cellular operating mode and a polarimetry operating mode. When in the cellular mode, the transceiver behaves as specified for the cellular technology being used by the cellular transceiver and base station 120 to transfer information and maintain attachment of UEs to the cell, and when in the polarimetry mode the cellular transceiver measures signal 122, which comprises orthogonal polarization components, as noted above. Examples of information transferred during the cellular operating mode include media streaming, file transfer and email correspondence. Of course in general also such parts of signal 121 will be received in the cellular transceiver of base station 120 which have not interacted with road 101 and thus carry no information on its surface conditions. On the other hand signal 122 does carry, in its polarization state, information on the surface conditions of road 101. The polarization state of signal 121 may be much simpler than that of signal 122. Beamforming may be employed to direct signal 121 toward the road surface, and base station 120 may be configured to scan the road surface by adapting its beamforming parameters, to obtain information on several sections of road 101. Using efficient beamforming may reduce the parts of signal 121 which are received in base station, not having interacted with patch 102. Performing the polarimetry measurement may thus comprise sweeping the beam of signal 121 by adjusting beamforming parameters accordingly, to point signal 121 along the trajectory of road 101, to obtain signal 122 reflected or backscattered from plural points along the route of road 101. Thus the polarimetry measurement may include learning not only whether road 101 has an icy or wet surface, but also where along road 101 this icy or wet surface is located

To open a time slot for the polarimetry mode, base station and/or a user equipment in which the cellular transceiver is comprised may increase a communication data rate immediately before, and/or after, the time slot. During the time slot, a polarimetry signal 121 is transmitted from base station 120, and the cellular transceiver of base station 120 is in the polarimetry mode to perform a polarimetry measurement to produce polarization measurement data on signal 122, to characterize the polarization state of signal 122. As the communication data rate was increased before and after the time slot, an overall communication data rate over a longer time period, which comprises the time slot, may be maintained constant or nearly so. The time slot for polarimetry may last, for example, 1 millisecond, ten milliseconds or a hundred milliseconds. In some embodiments, the communication data rate is not modified before or after the time slot for polarimetry, rather, a small delay in data communication is accepted by the system. An apparatus controlling the cellular transceiver may be the unit which estimates the road surface condition based on the polarization measurement data obtained from the cellular transceiver of base station 120.

In some embodiments a UE is configured to transmit a request for a polarimetry measurement to base station 120. Base station 120 may then decide to implement the polarimetry mode and signal in the downlink to inform user equipments of this, and when the double polarized polarimetry signal will be transmitted from base station 120 so that the user equipments will know to not expect cellular data during the time the base station transceiver is in the polarimetry mode. The base station may then measure the polarization state of reflected or scattered signal 122 to estimate the road surface condition.

An apparatus may maintain a database comprising plural estimates concerning the road surface, plural ones of the estimates being associated in the database with an indication of a location where the beamformed signal 121 was directed to. In some cases, all of the road surface estimates are associated with the respective indications of location, where the polarization measurement data used in the respective estimate was obtained. The road surface estimates may likewise be associated with time indications, indicating when the polarization measurement data used in the respective estimate was obtained. The database may thus have a record of estimated road surface condition for one or more roads, for sections of the road length, rather than just single locations long the road. The base station be configured to share its estimations of the road surface with a central server to enable alerting other vehicles driving along the same route, or approaching the same route, of wet or icy road surface conditions. In some embodiments, the base station directly wars UEs attached to a cell it controls concerning icy road surface conditions. Since the road surface condition varies with time, estimates older than a threshold age, for example two or four hours, may be considered obsolete and removed.

The UE, such as a smartphone or car data management system, may be configured to provide an alert to a driver of car 110 in case it receives a warning from base station 120, based on the polarization measurement data, that the road surface is wet or icy. Likewise the apparatus may alert the driver in case it received an indication from a central server that wet or icy conditions may prevail. In addition to alerting the driver, or alternatively to alerting the driver, the car data management system may modify at least one autonomous driving parameter of the vehicle, such as car 110, as a response to the received warning that wet or icy conditions may prevail. For example, the autonomous driving parameter may be a maximum speed which is reduced, a minimum distance to a vehicle driving in front which is increased, or a maximum speed in a curve which is reduced.

In some embodiments, plural cellular transceivers in base station 120 may participate in generating the polarization measurement data from signal 122. This may be the case, for example, where base station 120 has plural cellular transceivers. In this case, the cellular transceivers are switched into the polarimetry mode and used to receive signal 122 and collect polarization measurement data from the plural cellular transceivers. An advantage of using plural cellular transceivers is that performing more measurements on the same signal provides more information on the signal, enabling more dependable estimations on the road surface condition to be made based on the polarization measurement data which is more descriptive of the polarization state of signal 122.

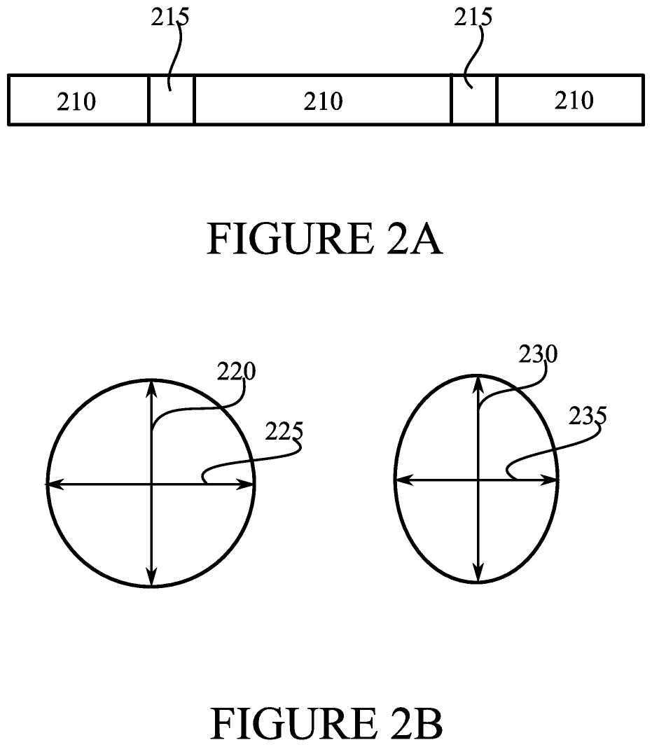

FIG. 2A illustrates timing in accordance with at least some embodiments of the present invention. In the figure, time advances from the left toward the right. Normal cellular communication takes place during time intervals 210, whereas time slots for polarimetry are present in the figure as slots 215. During slots 215, the base station provides the double polarized signal 121 comprising orthogonally polarized components, which is at least in part, and in some embodiments fully, devoid of encoding with information bits. During slots 215, the base station also measures the reflected or backscattered signal 122, as described herein above. When signal 121 is only partly devoid of encoding with information bits, it may comprise a part which is encoded with information bits and another part which is devoid of encoding with information bits.

FIG. 2B illustrates circular and elliptical polarizations. These are examples of double polarized signals comprising orthogonally polarized components, in particular, on the left, a circular polarization is illustrated with polarized components 220, 225 which are orthogonal to each other. Likewise, on the right, an elliptical polarization state is illustrated, where components 230, 235 have polarizations orthogonal to each other. In practical cases, such regular polarizations may be more typical of signal 121 transmitted from the base station in the polarimetry mode, than signal 122 which is signal 121 after signal 121 has interacted with the road surface, for example by reflection and/or backscattering. As the road surface is to an extent rough, the polarization will no longer be as regular as in the case of signal 121, and it may exhibit time variation in the receiving cellular transceiver which measures it and generates the polarization measurement data to characterize its polarization state. The polarization state of signal 122 may thus have aspects of randomness and statistical properties to it.

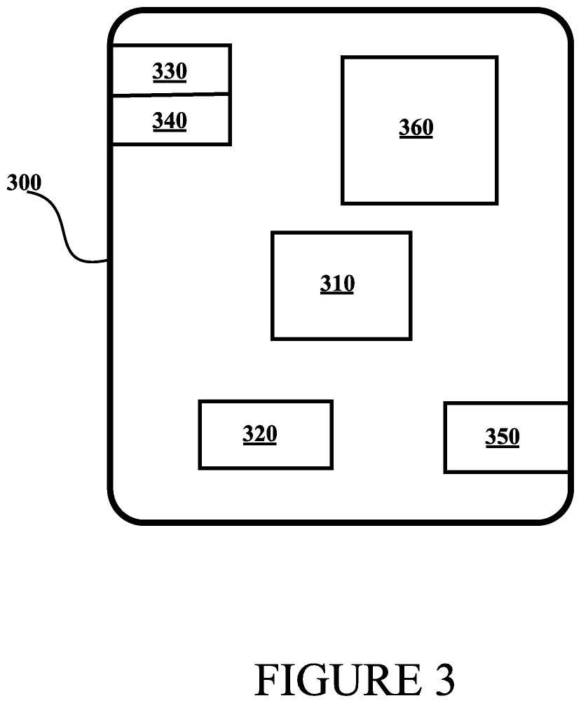

FIG. 3 illustrates an example apparatus capable of supporting at least some embodiments of the present invention. Illustrated is device 300, which may comprise, for example, a base station. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example. Transmitter 330 and receiver 340 are together, when configured to support a cellular technology, a cellular transceiver.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure communication parameters.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

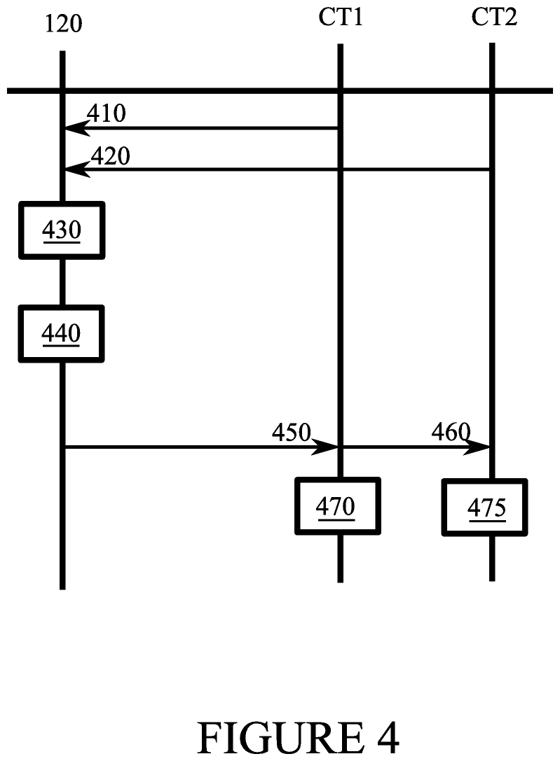

FIG. 4 illustrates signalling in accordance with at least some embodiments of the present invention. On the vertical axes are disposed, from the left to the right, base station 120 of FIG. 1, and cellular transceivers CT1 and CT2. The cellular transceivers are in vehicles, which may be different vehicles, in other words, the transceivers need not be in the same vehicle although they may be in the same vehicle. Time advances from the top toward the bottom.

In phases 410 and 420, cellular transceivers CT1 and CT2 transmit to base station 120 requests for a polarimetric measurement of the road surface. These requests may prompted by precipitation sensors in the respective vehicles indicating rain, or temperature sensors in the vehicles indicating that the prevailing temperature is dropping toward freezing temperatures. These requests may originate from apparatuses which control cellular transceivers CT1 and CT2.

In phase 430, base station 120 determines to transmit a polarimetry signal, such as signal 121 of FIG. 1. For example, base station 120 may be configured to agree to requests 410, 420 in case more than a threshold number of these requests arrive, from more than a second threshold number of user equipments, and more than a predetermined length of time has elapsed since the most recent previous polarimetry time slot. In some embodiments, the base station is instructed from the core network to transmit polarimetry signals, for example at a constant periodicity, when air temperature is below a threshold temperature. The constant periodicity may be configured from a core network node, for example based on a moisture content in the air in combination with the air temperature. For example, the periodicity may be small, that is, the polarimetry signals transmitted more frequency, in case moisture content in air is high when air temperature drops, compared to a situation where moisture content in air is low when air temperature drops.

In phase 440 base station 120 performs the polarimetry measurement, transmitting signal 121 and measuring reflected and/or backscattered signal 122, as described herein above, to determine whether the road surface is icy or wet. Performing the polarimetry measurement may comprise sweeping the beam of signal 121 by adjusting beamforming parameters accordingly, to point signal 121 along the trajectory of road 101, to obtain signal 122 reflected or backscattered from plural points along the route of road 101. Thus the polarimetry measurement may include learning not only whether road 101 has an icy or wet surface, but also where along road 101 this icy or wet surface is located.

In phases 440 and 450, base station 120 informs cellular transceivers CT1 and CT2, or user equipments respectively comprising these transceivers, of a result of phase 440, in particular, the informing of phases 450 and 460 may take place responsive to a determination that ice or water are present in the road surface. In case optional phases 410 and 420 are present, phases 450 and 460 may be performed also in case water or ice are not found.

In phases 470 and 475, cars carrying transceivers CT1 and CT2 act on the advice received in phases 450 and 460, respectively, for example by providing an icing alert or wet road alert to their driver, or by automatically adjusting an autonomous car driving parameter, such as reducing a maximum speed or switching to a slippery surface driving mode to reduce accident risk. Reducing the accident risk provides the technical benefit of enhancing road safety, also for other road users such as pedestrians and other vehicles.

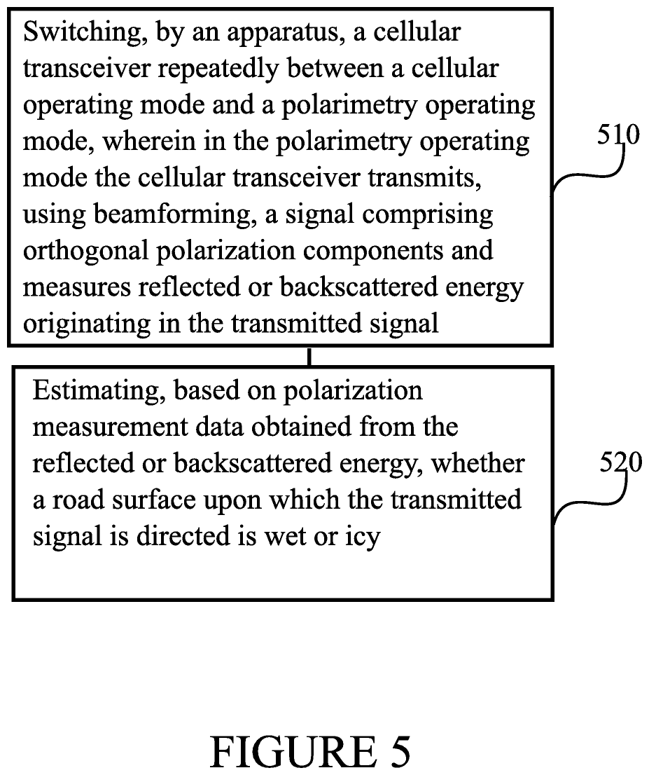

FIG. 5 is a flow graph of a method in accordance with at least some embodiments of the present invention. The phases of the illustrated method may be performed in an apparatus controlling a cellular transceiver in a vehicle, for example, or in a control device configured to control the functioning thereof, when installed therein.

Phase 510 comprises switching, by an apparatus, a cellular transceiver repeatedly between a cellular operating mode and a polarimetry operating mode, wherein in the polarimetry operating mode the cellular transceiver transmits, using beamforming, a signal comprising orthogonal polarization components and measures reflected or backscattered energy originating in the transmitted signal. Phase 520 comprises estimating, based on polarization measurement data obtained from the reflected or backscattered energy, whether a road surface toward which the transmitted signal is directed is wet or icy.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in estimating driving conditions.

1. An apparatus comprising at least one processing core and at least one memory storing instructions that, when executed by the at least one processing core, cause the apparatus at least to:
transmit a signal comprising orthogonal polarization components and measure reflected or backscattered energy originating in the transmitted signal, and
estimate based on polarization measurement data obtained from the reflected or backscattered energy, whether a road surface toward which the transmitted signal is directed is wet or icy, wherein
the apparatus is a cellular base station configured to switch a cellular transceiver repeatedly between a cellular operating mode and a polarimetry operating mode, wherein in the polarimetry operating mode the cellular transceiver transmits the signal using beamforming.

2. The apparatus according to claim 1, configured to perform the estimating based on one or more of: a circular polarization ratio, a polarization entropy or a polarization pedestal.

3. The apparatus according to claim 2, configured to perform the estimating based on the circular polarization ratio, wherein the apparatus is configured to estimate the road surface is icy as a response to the circular polarization ratio being in excess of a preconfigured threshold.

4. The apparatus according to claim 1, further configured to transmit the signal as a double polarized signal comprising the orthogonally polarized components.

5. The apparatus according to claim 1, further configured to maintain a database comprising plural estimates concerning the road surface plural ones of the estimates being each associated in the database with an indication of a location where the signal used in the respective estimate was directed to.

6. The apparatus according to claim 1, further configured to, responsive to the estimating indicating the road surface is wet or icy, provide an indication to at least one nearby vehicle that the road surface is wet or icy.

7. The apparatus according to claim 1, further configured to switch the cellular transceiver to the polarimetry mode as a response to determining that less than a first number of user equipments are attached in a cell controlled by the apparatus.

8. The apparatus according to claim 1, further configured to modify beamforming parameters to cause the signal to scan along the road surface along a trajectory of the road, when the cellular transceiver is in the polarimetry mode.

9. A method comprising:
transmitting by an apparatus a signal comprising orthogonal polarization components and measures reflected or backscattered energy originating in the transmitted signal, and
estimating, by the apparatus based on polarization measurement data obtained from the reflected or backscattered energy whether a road surface toward which the transmitted signal is directed is wet or icy, wherein
the apparatus is a cellular base station configured to switch a cellular transceiver repeatedly between a cellular operating mode and a polarimetry operating mode, wherein in the polarimetry operating mode the method comprises transmitting, by the cellular transceiver, the signal using beamforming.

10. The method according to claim 9, wherein the method comprises performing the estimating based on one or more of: a circular polarization ratio, a polarization entropy or a polarization pedestal.

11. The method according to claim 9, wherein the method comprises performing the estimating based on the circular polarization ratio, wherein the road surface is estimated to be icy as a response to the circular polarization ratio being in excess of a preconfigured threshold.

12. The method according to claim 9, wherein the method further comprises transmitting the signal as a double polarized signal comprising the orthogonally polarized components.

13. The method according to claim 9, further comprising maintaining a database comprising plural estimates concerning the road surface plural ones of the estimates being each associated in the database with an indication of a location where the signal used in the respective estimate was directed to.

14. The method according to claim 9, further comprising, responsive to the estimating indicating the road surface is wet or icy, provide an indication to at least one nearby vehicle that the road surface is wet or icy.

15. A non-transitory computer readable medium having stored thereon a set of computer readable instructions that, when executed by at least one processor, cause an apparatus to at least:
transmit, a signal comprising orthogonal polarization components and measures reflected or backscattered energy originating in the transmitted signal, and
estimate based on polarization measurement data obtained from the reflected or backscattered energy, whether a road surface toward which the transmitted signal is directed is wet or icy, wherein
the apparatus is a cellular base station configured to switch a cellular transceiver repeatedly between a cellular operating mode and a polarimetry operating mode, wherein in the polarimetry operating mode the cellular transceiver transmits the signal using beamforming.
